(19) United States
(12) Patent Application Publication
(10) Pub. No.: US 2026/0154447 A1
(43) Pub. Date: Jun. 4, 2026

(54) SYSTEM AND METHOD FOR MANAGING INTERACTIONS BETWEEN A CLIENT DEVICE AND AN AGENT DEVICE

(71) Applicant: The Toronto-Dominion Bank, Toronto (CA)

(72) Inventor: Babak RASTGOO, Toronto (CA)

(21) Appl. No.: 18/965,520

(22) Filed: Dec. 2, 2024

(51) Int. Cl. G06F 21/62; H04L 9/32

(52) U.S. Cl. CPC G06F 21/6254; H04L 9/3213

(57) ABSTRACT

Computing platforms, methods, and storage media for managing interactions between a client device and an agent device are disclosed. Exemplary implementations may: receive an indication to process personally identifiable information (PII) data in a chat system interaction between the client device and the agent device; tokenize the PII data; transmit the tokenized PII data on a first channel via a chat system server to the agent device; transmit the received and untokenized PII data on a second channel via a secure connection to the agent device; and cause display at the agent device of a correlation between the untokenized PII data and the tokenized PII data.

### FIELD

The present disclosure relates to data communications, including but not limited to computing platforms, methods, and storage media for managing interactions between a client device and an agent device.

### BACKGROUND

In data communications, a chat system may provide a convenient way for a client using a client device to interact with an agent using an agent device. The chat system may enable real-time or near real-time interaction, with the convenience of accessing the chat from any device enabled to connect to the chat server.

In the course of a chat between a client and an agent, a variety of different data may be exchanged. A chat transcript is often generated based on the chat interaction, and in some cases is mandated or required. If personally identifiable information (PII) is to be exchanged in the chat, this can pose an issue, for example with respect to storage of the PII data in a chat transcript.

Improvements in approaches for managing interactions between a client device and an agent device are desirable.

### BRIEF DESCRIPTION OF THE DRAWINGS

Embodiments of the present disclosure will now be described, by way of example only, with reference to the attached Figures.

FIG. 1 illustrates a block and flow diagram of a system configured for managing interactions between a client device and an agent device, in accordance with one or more embodiments.

FIG. 2 illustrates a system configured for managing interactions between a client device and an agent device, in accordance with one or more embodiments.

FIG. 3 illustrates a method for managing interactions between a client device and an agent device, in accordance with one or more embodiments.

### DETAILED DESCRIPTION

Computing platforms, methods, and storage media for managing interactions between a client device and an agent device are disclosed. Exemplary implementations may: receive an indication to process personally identifiable information data in a chat system interaction between the client device and the agent device; tokenize the PII data; transmit the tokenized PII data on a first channel via a chat system server to the agent device; transmit the received and untokenized PII data on a second channel via a secure connection to the agent device; and cause display at the agent device of a correlation between the untokenized PII data and the tokenized PII data.

In accordance with one or more embodiments, the present disclosure provides a platform to enable selective tokenization of personally identifiable information sent in a chat interaction to prevent saving PII to a transcript, while passing the PII data from a client to an agent in a parallel secure connection.

Personally identifiable information (PII) is defined in a National Institute of Standards and Technology (NIST) document, based on a United States Government Accountability Office report, as “any information about an individual maintained by an agency, including (1) any information that can be used to distinguish or trace an individual's identity, such as name, social security number, date and place of birth, mother's maiden name, or biometric records; and (2) any other information that is linked or linkable to an individual, such as medical, educational, financial, and employment information.” PII comprises sensitive data subject to information governance. PII may include payment card information (PCI) or personal health information (PHI).

In accordance with one or more embodiments, the present disclosure provides a system to manage PII data in a chat system interaction between a client device and an agent device. The system may receive an indication to process PII data in a chat system interaction, and to selectively process the PII data in a different way than processing of non-PII chat data. The PII data may be tokenized and sent through the chat system, and the untokenized PII data may be sent via a parallel secure connection to the agent device. The system may enable the agent device to correlate the tokenized PII data sent via the chat system with the untokenized PII data sent via the secure connection, without leaving a chat system window or interface. The selective processing may be performed in response to an agent prompt, or based on detection of PII data.

One aspect of the present disclosure relates to an apparatus or a computing platform configured for managing interactions between a client device and an agent device. The apparatus or computing platform may include a non-transient computer-readable storage medium having executable instructions embodied thereon. The apparatus or computing platform may include one or more hardware processors configured to execute the instructions. The processor(s) may execute the instructions to receive an indication to process personally identifiable information data in a chat system interaction between the client device and the agent device. The processor(s) may execute the instructions to tokenize the PII data. The processor(s) may execute the instructions to transmit the tokenized PII data on a first channel via a chat system server to the agent device. The processor(s) may execute the instructions to transmit the received and untokenized PII data on a second channel via a secure connection to the agent device. The processor(s) may execute the instructions to cause display at the agent device of a correlation between the untokenized PII data and the tokenized PII data.

Another aspect of the present disclosure relates to a method for managing interactions between a client device and an agent device. The method may include receiving an indication to process personally identifiable information data in a chat system interaction between the client device and the agent device. The method may include tokenizing the PII data. The method may include transmitting the tokenized PII data on a first channel via a chat system server to the agent device. The method may include transmitting the received and untokenized PII data on a second channel via a secure connection to the agent device. The method may include causing display at the agent device of a correlation between the untokenized PII data and the tokenized PII data.

Yet another aspect of the present disclosure relates to a non-transient computer-readable storage medium having instructions embodied thereon, the instructions being executable by one or more processors to perform a method for managing interactions between a client device and an agent device. The method may include receiving an indication to process personally identifiable information data in a chat system interaction between the client device and the agent device. The method may include tokenizing the PII data. The method may include transmitting the tokenized PII data on a first channel via a chat system server to the agent device. The method may include transmitting the received and untokenized PII data on a second channel via a secure connection to the agent device. The method may include causing display at the agent device of a correlation between the untokenized PII data and the tokenized PII data.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

In accordance with one or more embodiments, the present disclosure provides a system that enables exchange of various types of data in a chat interaction between a client and an agent, or between a client device and an agent device, including PII data.

According to a first known approach, a chat system does not support PII, so the agent tells the client not to send PII data. According to a second known approach, if an agent or a client needs to send PII data, a link to a form is sent, and the data is entered in the form, which is separate from the chat system. For example, when a client is talking to an agent, if the agent requires secure data or requires structured data, the agent may send a form via a link to the client, where the client enters the PII data in the form, and sends it. However, forms need to be configured ahead of time, which involves time and effort and processing power. In this scenario, the client has to leave the chat experience to enter the PII data and then come back to the chat experience.

There is a technical problem associated with known approaches in that there is no automated or reliable way to process PII data in a chat system, so that the PII data is not stored in a chat transcript, but the PII data is still conveyed to the agent in a manner that is integrated with or adjacent to a chat system interface. In accordance with one or more embodiments of the present disclosure, a technical solution is provided including a system and method to tokenize PII data and send the tokenized PII data to an agent device via the chat system, and to send the untokenized PII data in parallel via a secure connection to the agent device, so that the agent device is able to correlate the tokenized PII data with the untokenized PII data.

A solution in accordance with one or more embodiments of the present disclosure is configured keep the client in the chat while sending and properly processing the PII data, for example such that PII data is not saved in a chat transcript.

In an example embodiment, the present disclosure provides a module placed in between a client device and a chat system to check if data sent to the chat system is PII/PCI; if yes, the data is treated differently.

In many systems, there is a security requirement that data has to be encrypted everywhere, and PII data must be removed from a transcript while complying with a book of record requirement.

In accordance with one or more embodiments of the present disclosure, a Chat PEP (policy enforcement point) server may be implemented that talks to a chat services server, and an agent UI is provided. When a client sends PII data, the chat PEP tokenizes data and sends to a chat system server associated with the chat system vendor. The agent sees tokenized or masked information in the chat system. The chat PEP system sees the data, tags it as PII, causes display of the PII in a UI that is linked to the chat system, and the agent sees it at agent side. So, for example, when a client enters credit card info, the system sees the information in the UI and it is treated differently.

The chat PEP server may use a regular expression, or a third party can pass data, clean it, find out what is inside it. There may be 3 use cases covered according to embodiments of the present disclosure:
1—Use of regular expression: client sends data, check data in chat PEP server, clean, tag, save and present to agent and keep it as book of record
2—Agent wants to have an answer and wants the answer proactively tagged. The agent sends a phrase, or passes a code. The system considers the next response from the client to be tagged and encrypted and saved.
3—Agent wants a block of conversation to be tagged and not saved in chat transcript, but saved differently. The agent device would send a start and end command, and everything between would be tagged and saved in the database and sent to the agent separately.

From a client experience perspective, the client never gets out of the chat interface. The chat PEP server does all of the heavy lifting, and satisfies security and compliance requirements.

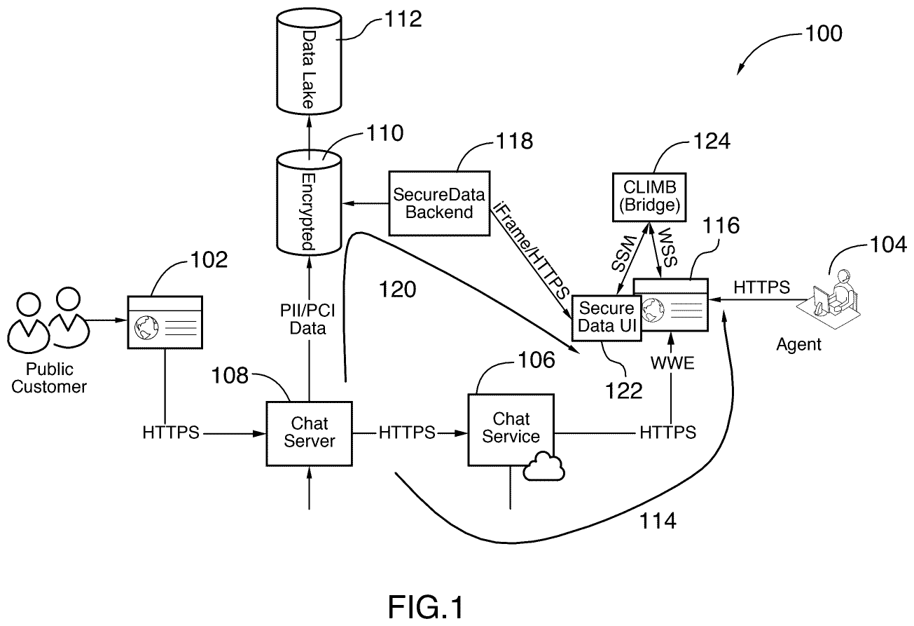

FIG. 1 illustrates a block and flow diagram 100 of a system configured for managing interactions between a client device 102 and an agent device 104, in accordance with one or more embodiments. A chat service 106 in FIG. 1 is not PCI compliant, and cannot handle PII/PCI data. Many chat services such as Genesys do not have inherent PII/PCI data functionality.

A chat apparatus or chat server 108, also referred to as Chat PEP, may be configured to tokenize PII data, and save the untokenized PII data to an encrypted database 110, which may be in communication with a data lake 112. The chat apparatus 108 may then send or transmit the tokenized data on a first channel 114 to the chat service 106, for example for display at a first chat UI 116. A secure data backend component 118 may be configured to read the untokenized data from the encrypted database 110, and when new data comes in, the untokenized data may be transmitted via a second channel 120 via a secure connection to the agent device 104 via a secure data UI 122 that is presented to the agent. The system may comprise a bridge 124, such as Climb, that can provide connectivity between the two UIs 116 and 122. The secure data, or untokenized data, and the chat data, or tokenized data, may be integrated within the on-screen application at the agent device 104.

The chat server 108 can provide PII processing capabilities for any chat service 106, making it possible to add PII processing to any chat service 106, as an add-on functionality, without modifying the chat service itself.

The chat server 108 may: proactively intercept data, not knowing whether it is PII or not; determine whether it is PII data; tag the PII data in the conversation; and then process PII data separately. Secure data may be sent to the agent device in a different UI element beside the chat, but not inside the chat.

In FIG. 1, the chat service 106 sees the tokenized data, and not the untokenized data, because the tokenized data is part of the chat. If it becomes necessary to look at the chat transcript, the agent needs to be able to go back and link the tokenized data with the untokenized data that was actually sent.

For example, suppose a client sends a 16-digit credit card number as PII data, and the system tokenizes the PII data to a result of UF31. In this case, the 16-digit credit card number comprises untokenized PII data, and the result of UF31 comprises tokenized PII data, which is a tokenized version of the 16-digit credit card number. The 16-digit credit card number may be stored in the secure database 110. The system may map the result of UF31 as representing the credit card number stored in the secure database 110. The value UF31 may be sent via a first channel 114 to the chat services server 106, as a tokenized version of the PII data which is the credit card number. The credit card number may be transmitted on a second channel 120 via a secure connection to the agent device 104.

The agent device 104 may have a display device configured to display 2 windows, or portions of a UI in the same window: a first or primary window, or first portion of a user interface, 116 displaying the actual chat transcript with tokenized data; and a second or secondary window, or second portion of a user interface, 122, that gets updated in real-time and provides the PII/PCI portion of the conversation.

In an example embodiment, the chat server 108 is configured to: receive an indication to process personally identifiable information data in a chat system interaction between the client device and the agent device; tokenize the PII data; transmit the tokenized PII data on a first channel via a chat system server to the agent device; transmit the received and untokenized PII data on a second channel via a secure connection to the agent device; and cause display at the agent device of a correlation between the untokenized PII data and the tokenized PII data.

In another example implementation, PII data “451” gets tokenized and converted to “AW3” in the chat. In window 1 shown as 116, the agent sees “AW3” in the chat window. In window 2 shown as 122, the agent sees “AW3”=451. This may be implemented as, or appear as, one window for the agent, but may in fact comprise two sub-sections of the same window. Embodiments of the present disclosure may be configured to create and embed a second section within the chat services window, or embed the existing chat services window into a PII-enabled chat services meta-window that includes the new PII-specific information.

The system 100 may start with receiving an indication of a requirement to process PII data. The system 100 may selectively process PII chat data in a different way than regular processing of chat data.

Sometimes there is data that should be treated differently, but it is difficult to identify as PII data. For example, if a person's address or name is PII data, sometimes a system cannot proactively predict or easily recognize what information is PII data, since some names or addresses may be difficult to recognize, such as with respect to stored examples, algorithms or trained data models. In an implementation, the agent has the ability to separate a block of data, whether or not the chat server 108 is proactively trying to identify PII data. This can add a layer of security, to ensure that incoming data in response to a specific question from an agent, for example, is treated and processed as PII data, regardless of whether the system is able to proactively identify it as PII data.

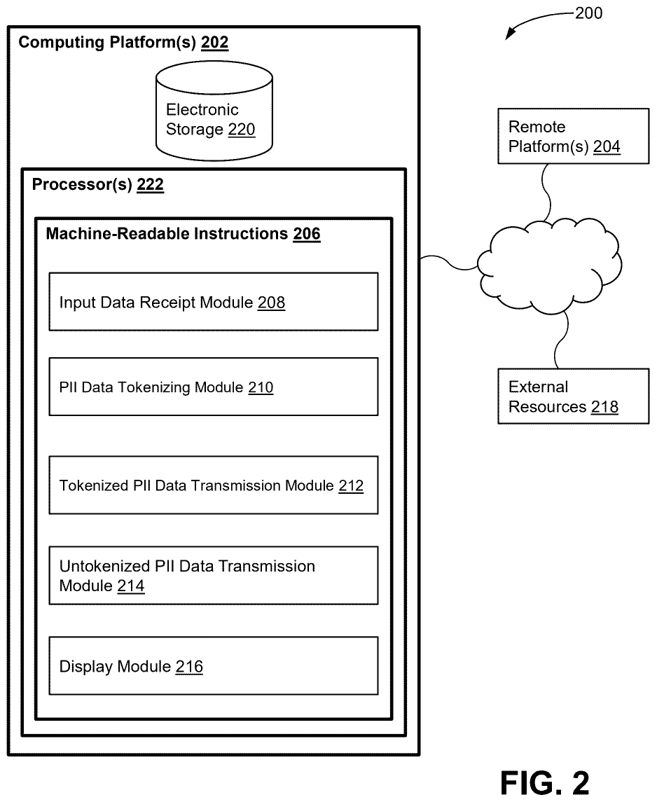

FIG. 2 illustrates a system 200 configured for managing interactions between a client device and an agent device, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of input data receipt module 208, PII data tokenizing module 210, tokenized PII data transmission module 212, untokenized PII data transmission module 214, display module 216, and/or other instruction modules.

Input data receipt module 208 may be configured to receive an indication to process personally identifiable information data in a chat system interaction between the client device and the agent device. Input data receipt module 208 may also be configured to receive input data from the client device and generate the indication to process PII data in response to determining that the input data comprises PII data. Additionally, input data receipt module 208 may be configured to receive a tagging indicator from the agent device and generate the indication to process PII data in communication received from the client device in response to receiving the tagging indicator. The tagging indicator may be generated in response to an agent device providing a tagging instruction.

Input data receipt module 208 may further be configured to receive a next response tagging indicator from the agent device and generate the indication to process PII data in a next communication received from the client device in response to receiving the next response tagging indicator. Input data receipt module 208 may also be configured to receive a block tagging indicator from the agent device and generate the indication to process PII data in a conversation block received from the client device in response to receiving the block tagging indicator. The next response tagging indicator or the block tagging indicator may be generated in response to an agent device providing a next response tagging instruction or a block tagging instruction, respectively.

Input data receipt module 208 may be configured to intercept first chat interaction data from the client device intended for the agent device. Input data receipt module 208 may be configured to determine whether the first chat interaction data comprises PII data. Input data receipt module 208 may be configured to generate the indication to process PII data in response to determining that the first chat interaction comprises PII data.

PII data tokenizing module 210 may be configured to tokenize the PII data. PII data tokenizing module 210 may tokenize the data in response to receipt of an indication to process PII data in response to determining that the input data comprises PII data. PII data tokenizing module 210 may also be configured to automatically tokenize the first chat interaction data in response to receiving the indication to process PII data, even in response to determining that the first chat interaction is free of PII data, to mitigate for a potential inadvertent incorrect determination of whether the first chat interaction comprises PII data.

Tokenized PII data transmission module 212 may be configured to transmit the tokenized PII data on a first channel via a chat system server to the agent device, for example as described and illustrated above in relation to FIG. 1.

Untokenized PII data transmission module 214 may be configured to transmit the received and untokenized PII data on a second channel via a secure connection to the agent device, for example as described and illustrated above in relation to FIG. 1. Untokenized PII data transmission module 214 may also be configured to save the tokenized PII data to an encrypted database and obtain the tokenized PII data from the encrypted database to transmit on the first channel. Untokenized PII data transmission module 214 may also be configured to transmit the untokenized PII data on the second channel so as to prevent storage of the untokenized PII data in a chat system server transcript. Additionally, untokenized PII data transmission module 214 may be configured to transmit the untokenized PII data on the second channel in parallel with transmitting the tokenized PII data on the first channel.

Display module 216 may be configured to cause display at the agent device of a correlation between the untokenized PII data and the tokenized PII data. Display module 216 may also be configured to cause display of the correlation between the received PII data and the tokenized PII data such that the correlation appears within a chat system interface at the agent device. Additionally, display module 216 may be configured to cause display of the correlation between the received PII data and the tokenized PII data such that the correlation appears in a first user interface (UI) element of an application at the agent device, the first UI element being adjacent a second UI element of the application at the agent device, the second UI element comprising a chat system interface.

Display module 216 may be configured to cause display at the agent device of the untokenized PII data and the tokenized PII data as well as the correlation between the untokenized PII data and the tokenized PII data. Display module 216 may be configured to cause concurrent display at the agent device of the untokenized PII data and the tokenized PII data as well as the correlation between the untokenized PII data and the tokenized PII data.

Display module 216 may be configured to cause display of the correlation between the received PII data and the tokenized PII data such that the correlation appears within a chat system interface at the agent device. Display module 216 may be configured to cause display of the correlation between the received PII data and the tokenized PII data such that the correlation appears in a first user interface UI element of an application at the agent device, the first UI element being adjacent a second UI element of the application at the agent device, the second UI element comprising a chat system interface.

In some embodiments, computing platform(s) 202, remote platform(s) 204, and/or external resources 218 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 218 may be operatively linked via some other communication media.

A given remote platform 204 may include one or more processors configured to execute computer program modules. The computer program modules may be configured to enable an expert or user associated with the given remote platform 204 to interface with system 200 and/or external resources 218, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 218 may include sources of information outside of system 200, external entities participating with system 200, and/or other resources. In some embodiments, some or all of the functionality attributed herein to external resources 218 may be provided by resources included in system 200.

Computing platform(s) 202 may include electronic storage 220, one or more processors 222, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 220 may comprise non-transitory storage media that electronically stores information. The electronic storage media of electronic storage 220 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 220 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 220 may include one or more virtual storage resources (e.g., cloud storage, a virtual private network, and/or other virtual storage resources). Electronic storage 220 may store software algorithms, information determined by processor(s) 222, information received from computing platform(s) 202, information received from remote platform(s) 204, and/or other information that enables computing platform(s) 202 to function as described herein.

Processor(s) 222 may be configured to provide information processing capabilities in computing platform(s) 202. As such, processor(s) 222 may include one or more of a digital processor, an analog processor, a digital circuit designed to process information, an analog circuit designed to process information, a state machine, and/or other mechanisms for electronically processing information. Although processor(s) 222 is shown in FIG. 2 as a single entity, this is for illustrative purposes only. In some embodiments, processor(s) 222 may include a plurality of processing units. These processing units may be physically located within the same device, or processor(s) 222 may represent processing functionality of a plurality of devices operating in coordination. Processor(s) 222 may be configured to execute modules 208, 210, 212, 214, 216, and/or 218, and/or other modules. Processor(s) 222 may be configured to execute modules 208, 210, 212, 214, 216, and/or 218, and/or other modules by software; hardware; firmware; some combination of software, hardware, and/or firmware; and/or other mechanisms for configuring processing capabilities on processor(s) 222. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, and/or 218 are illustrated in FIG. 2 as being implemented within a single processing unit, in embodiments in which processor(s) 222 includes multiple processing units, one or more of modules 208, 210, 212, 214, 216, and/or 218 may be implemented remotely from the other modules. The description of the functionality provided by the different modules 208, 210, 212, 214, 216, and/or 218 described below is for illustrative purposes, and is not intended to be limiting, as any of modules 208, 210, 212, 214, 216, and/or 218 may provide more or less functionality than is described. For example, one or more of modules 208, 210, 212, 214, 216, and/or 218 may be eliminated, and some or all of its functionality may be provided by other ones of modules 208, 210, 212, 214, 216, and/or 218. As another example, processor(s) 222 may be configured to execute one or more additional modules that may perform some or all of the functionality attributed below to one of modules 208, 210, 212, 214, 216, and/or 218.

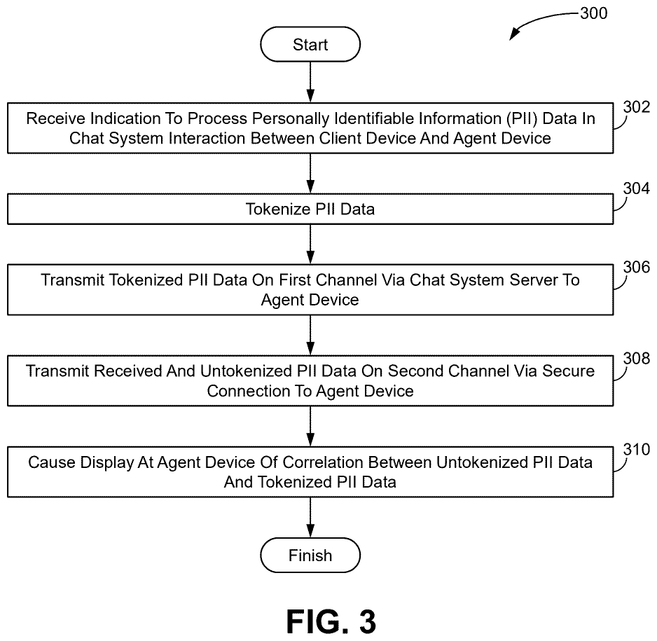

FIG. 3 illustrates a method 300 for managing interactions between a client device and an agent device, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include receiving an indication to process personally identifiable information (PII) data in a chat system interaction between the client device and the agent device. Operation 302 may be performed by one or more hardware processors configured by machine-readable instructions including a module that is the same as or similar to module 208, in accordance with one or more embodiments.

An operation 304 may include tokenizing the PII data. Operation 304 may be performed by one or more hardware processors configured by machine-readable instructions including a module that is the same as or similar to module 210, in accordance with one or more embodiments.

An operation 306 may include transmitting the tokenized PII data on a first channel via a chat system server to the agent device. Operation 306 may be performed by one or more hardware processors configured by machine-readable instructions including a module that is the same as or similar to module 212, in accordance with one or more embodiments.

An operation 308 may include transmitting the received and untokenized PII data on a second channel via a secure connection to the agent device. Operation 308 may be performed by one or more hardware processors configured by machine-readable instructions including a module that is the same as or similar to module 214, in accordance with one or more embodiments.

An operation 310 may include causing display at the agent device of a correlation between the untokenized PII data and the tokenized PII data. Operation 310 may be performed by one or more hardware processors configured by machine-readable instructions including a module that is the same as or similar to module 216, in accordance with one or more embodiments.

In accordance with one or more embodiments, the present disclosure provides a platform to enable selective tokenization of personally identifiable information sent in a chat interaction to prevent saving PII to a transcript, while passing the PII data from a client to an agent in a parallel secure connection. In accordance with one or more embodiments, the present disclosure provides a system to manage PII data in a chat system interaction between a client device and an agent device. The system may receive an indication to process PII data in a chat system interaction, and to selectively process the PII data in a different way than processing of non-PII chat data. The PII data may be tokenized and sent through the chat system, and the untokenized PII data may be sent via a parallel secure connection to the agent device. The system may enable the agent device to correlate the tokenized PII data sent via the chat system with the untokenized PII data sent via the secure connection, without leaving a chat system window or interface. The selective processing may be performed in response to an agent prompt, or based on detection of PII data.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for managing interactions between a client device and an agent device. The system may include one or more hardware processors configured by machine-readable instructions. The processor(s) may be configured to receive an indication to process personally identifiable information (PII) data in a chat system interaction between the client device and the agent device. The processor(s) may be configured to tokenize the PII data. The processor(s) may be configured to transmit the tokenized PII data on a first channel via a chat system server to the agent device. The processor(s) may be configured to transmit the received and untokenized PII data on a second channel via a secure connection to the agent device. The processor(s) may be configured to cause display at the agent device of a correlation between the untokenized PII data and the tokenized PII data.

In some implementations of the system, the processor(s) may be configured to cause display at the agent device of the untokenized PII data and the tokenized PII data as well as the correlation between the untokenized PII data and the tokenized PII data. In some implementations of the system, the processor(s) may be configured to cause concurrent display at the agent device of the untokenized PII data and the tokenized PII data as well as the correlation between the untokenized PII data and the tokenized PII data.

In some implementations of the system, the processor(s) may be configured to transmit the untokenized PII data on the second channel so as to prevent storage of the untokenized PII data in a chat system server transcript. In some implementations of the system, the processor(s) may be configured to transmit the untokenized PII data on the second channel in parallel with transmitting the tokenized PII data on the first channel.

In some implementations of the system, the processor(s) may be configured to cause display of the correlation between the received PII data and the tokenized PII data such that the correlation appears within a chat system interface at the agent device. In some implementations of the system, the processor(s) may be configured to cause display of the correlation between the received PII data and the tokenized PII data such that the correlation appears in a first user interface (UI) element of an application at the agent device, the first UI element being adjacent a second UI element of the application at the agent device, the second UI element comprising a chat system interface.

In some implementations of the system, the processor(s) may be configured to intercept first chat interaction data from the client device intended for the agent device. In some implementations of the system, the processor(s) may be configured to determine whether the first chat interaction data comprises PII data. In some implementations of the system, the processor(s) may be configured to generate the indication to process PII data in response to determining that the first chat interaction comprises PII data.

In some implementations of the system, the processor(s) may be configured to automatically tokenize the first chat interaction data in response to receiving the indication to process PII data, even in response to determining that the first chat interaction is free of PII data, to mitigate for a potential inadvertent incorrect determination of whether the first chat interaction comprises PII data.

In some implementations of the system, the processor(s) may be configured to receive input data from the client device. In some implementations of the system, the processor(s) may be configured to generate the indication to process PII data in response to determining that the input data comprises PII data.

In some implementations of the system, the processor(s) may be configured to receive a tagging indicator from the agent device. In some implementations of the system, the processor(s) may be configured to generate the indication to process PII data in communication received from the client device in response to receiving the tagging indicator.

In some implementations of the system, the processor(s) may be configured to receive a next response tagging indicator from the agent device. In some implementations of the system, the processor(s) may be configured to generate the indication to process PII data in a next communication received from the client device in response to receiving the next response tagging indicator.

In some implementations of the system, the processor(s) may be configured to receive a block tagging indicator from the agent device. In some implementations of the system, the processor(s) may be configured to generate the indication to process PII data in a conversation block received from the client device in response to receiving the block tagging indicator.

In some implementations of the system, the processor(s) may be configured to receive a next response tagging indicator from the agent device. In some implementations of the system, the processor(s) may be configured to generate the indication to process PII data in a next communication received from the client device in response to receiving the next response tagging indicator.

In some implementations of the system, the processor(s) may be configured to save the tokenized PII data to an encrypted database. In some implementations of the system, the processor(s) may be configured to obtain the tokenized PII data from the encrypted database to transmit on the first channel.

Another aspect of the present disclosure relates to a method of managing interactions between a client device and an agent device. The method may include receiving an indication to process personally identifiable information (PII) data in a chat system interaction between the client device and the agent device. The method may include tokenizing the PII data. The method may include transmitting the tokenized PII data on a first channel via a chat system server to the agent device. The method may include transmitting the received and untokenized PII data on a second channel via a secure connection to the agent device. The method may include causing display at the agent device of a correlation between the untokenized PII data and the tokenized PII data.

In some implementations of the method, it may include causing display at the agent device of the untokenized PII data and the tokenized PII data as well as the correlation between the untokenized PII data and the tokenized PII data.

In some implementations of the method, it may include causing concurrent display at the agent device of the untokenized PII data and the tokenized PII data as well as the correlation between the untokenized PII data and the tokenized PII data.

In some implementations of the method, it may include transmitting the untokenized PII data on the second channel so as to prevent storage of the untokenized PII data in a chat system server transcript.

In some implementations of the method, it may include transmitting the untokenized PII data on the second channel in parallel with transmitting the tokenized PII data on the first channel.

In some implementations of the method, it may include causing display of the correlation between the received PII data and the tokenized PII data such that the correlation appears within a chat system interface at the agent device.

In some implementations of the method, it may include causing display of the correlation between the received PII data and the tokenized PII data such that the correlation appears in a first user interface (UI) element of an application at the agent device, the first UI element being adjacent a second UI element of the application at the agent device, the second UI element comprising a chat system interface.

In some implementations of the method, it may include intercepting first chat interaction data from the client device intended for the agent device. In some implementations of the method, it may include determining whether the first chat interaction data comprises PII data. In some implementations of the method, it may include generating the indication to process PII data in response to determining that the first chat interaction comprises PII data.

In some implementations of the method, it may include automatically tokenizing the first chat interaction data in response to receiving the indication to process PII data, even in response to determining that the first chat interaction is free of PII data, to mitigate for a potential inadvertent incorrect determination of whether the first chat interaction comprises PII data.

In some implementations of the method, it may include receiving input data from the client device. In some implementations of the method, it may include generating the indication to process PII data in response to determining that the input data comprises PII data.

In some implementations of the method, it may include receiving a tagging indicator from the agent device. In some implementations of the method, it may include generating the indication to process PII data in communication received from the client device in response to receiving the tagging indicator.

In some implementations of the method, it may include receiving a next response tagging indicator from the agent device. In some implementations of the method, it may include generating the indication to process PII data in a next communication received from the client device in response to receiving the next response tagging indicator.

In some implementations of the method, it may include receiving a block tagging indicator from the agent device. In some implementations of the method, it may include generating the indication to process PII data in a conversation block received from the client device in response to receiving the block tagging indicator.

In some implementations of the method, it may include receiving a next response tagging indicator from the agent device. In some implementations of the method, it may include generating the indication to process PII data in a next communication received from the client device in response to receiving the next response tagging indicator.

In some implementations of the method, it may include saving the tokenized PII data to an encrypted database. In some implementations of the method, it may include obtaining the tokenized PII data from the encrypted database to transmit on the first channel.

Yet another aspect of the present disclosure relates to a non-transient computer-readable storage medium having instructions embodied thereon, the instructions being executable by one or more processors to perform a method of managing interactions between a client device and an agent device. The method may include receiving an indication to process personally identifiable information (PII) data in a chat system interaction between the client device and the agent device. The method may include tokenizing the PII data. The method may include transmitting the tokenized PII data on a first channel via a chat system server to the agent device. The method may include transmitting the received and untokenized PII data on a second channel via a secure connection to the agent device. The method may include causing display at the agent device of a correlation between the untokenized PII data and the tokenized PII data.

In some implementations of the computer-readable storage medium, the method may include causing display at the agent device of the untokenized PII data and the tokenized PII data as well as the correlation between the untokenized PII data and the tokenized PII data. In some implementations of the computer-readable storage medium, the method may include causing concurrent display at the agent device of the untokenized PII data and the tokenized PII data as well as the correlation between the untokenized PII data and the tokenized PII data.

In some implementations of the computer-readable storage medium, the method may include transmitting the untokenized PII data on the second channel so as to prevent storage of the untokenized PII data in a chat system server transcript. In some implementations of the computer-readable storage medium, the method may include transmitting the untokenized PII data on the second channel in parallel with transmitting the tokenized PII data on the first channel.

In some implementations of the computer-readable storage medium, the method may include causing display of the correlation between the received PII data and the tokenized PII data such that the correlation appears within a chat system interface at the agent device. In some implementations of the computer-readable storage medium, the method may include causing display of the correlation between the received PII data and the tokenized PII data such that the correlation appears in a first user interface (UI) element of an application at the agent device, the first UI element being adjacent a second UI element of the application at the agent device, the second UI element comprising a chat system interface.

In some implementations of the computer-readable storage medium, the method may include intercepting first chat interaction data from the client device intended for the agent device. In some implementations of the computer-readable storage medium, the method may include determining whether the first chat interaction data comprises PII data. In some implementations of the computer-readable storage medium, the method may include generating the indication to process PII data in response to determining that the first chat interaction comprises PII data.

In some implementations of the computer-readable storage medium, the method may include automatically tokenizing the first chat interaction data in response to receiving the indication to process PII data, even in response to determining that the first chat interaction is free of PII data, to mitigate for a potential inadvertent incorrect determination of whether the first chat interaction comprises PII data.

In some implementations of the computer-readable storage medium, the method may include receiving input data from the client device. In some implementations of the computer-readable storage medium, the method may include generating the indication to process PII data in response to determining that the input data comprises PII data.

In some implementations of the computer-readable storage medium, the method may include receiving a tagging indicator from the agent device. In some implementations of the computer-readable storage medium, the method may include generating the indication to process PII data in communication received from the client device in response to receiving the tagging indicator.

In some implementations of the computer-readable storage medium, the method may include receiving a next response tagging indicator from the agent device. In some implementations of the computer-readable storage medium, the method may include generating the indication to process PII data in a next communication received from the client device in response to receiving the next response tagging indicator.

In some implementations of the computer-readable storage medium, the method may include receiving a block tagging indicator from the agent device. In some implementations of the computer-readable storage medium, the method may include generating the indication to process PII data in a conversation block received from the client device in response to receiving the block tagging indicator.

In some implementations of the computer-readable storage medium, the method may include saving the tokenized PII data to an encrypted database. In some implementations of the computer-readable storage medium, the method may include obtaining the tokenized PII data from the encrypted database to transmit on the first channel.

Still another aspect of the present disclosure relates to a system configured for managing interactions between a client device and an agent device. The system may include means for receiving an indication to process personally identifiable information (PII) data in a chat system interaction between the client device and the agent device. The system may include means for tokenizing the PII data. The system may include means for transmitting the tokenized PII data on a first channel via a chat system server to the agent device. The system may include means for transmitting the received and untokenized PII data on a second channel via a secure connection to the agent device. The system may include means for causing display at the agent device of a correlation between the untokenized PII data and the tokenized PII data.

In some implementations of the system, the system may include means for causing display at the agent device of the untokenized PII data and the tokenized PII data as well as the correlation between the untokenized PII data and the tokenized PII data.

In some implementations of the system, the system may include means for causing concurrent display at the agent device of the untokenized PII data and the tokenized PII data as well as the correlation between the untokenized PII data and the tokenized PII data.

In some implementations of the system, the system may include means for transmitting the untokenized PII data on the second channel so as to prevent storage of the untokenized PII data in a chat system server transcript.

In some implementations of the system, the system may include means for transmitting the untokenized PII data on the second channel in parallel with transmitting the tokenized PII data on the first channel.

In some implementations of the system, the system may include means for causing display of the correlation between the received PII data and the tokenized PII data such that the correlation appears within a chat system interface at the agent device.

In some implementations of the system, the system may include means for causing display of the correlation between the received PII data and the tokenized PII data such that the correlation appears in a first user interface (UI) element of an application at the agent device, the first UI element being adjacent a second UI element of the application at the agent device, the second UI element comprising a chat system interface.

In some implementations of the system, the system may include means for intercepting first chat interaction data from the client device intended for the agent device. In some implementations of the system, the system may include means for determining whether the first chat interaction data comprises PII data. In some implementations of the system, the system may include means for generating the indication to process PII data in response to determining that the first chat interaction comprises PII data.

In some implementations of the system, the system may include means for automatically tokenizing the first chat interaction data in response to receiving the indication to process PII data, even in response to determining that the first chat interaction is free of PII data, to mitigate for a potential inadvertent incorrect determination of whether the first chat interaction comprises PII data.

In some implementations of the system, the system may include means for receiving input data from the client device. In some implementations of the system, the system may include means for generating the indication to process PII data in response to determining that the input data comprises PII data.

In some implementations of the system, the system may include means for receiving a tagging indicator from the agent device. In some implementations of the system, the system may include means for generating the indication to process PII data in communication received from the client device in response to receiving the tagging indicator.

In some implementations of the system, the system may include means for receiving a next response tagging indicator from the agent device. In some implementations of the system, the system may include means for generating the indication to process PII data in a next communication received from the client device in response to receiving the next response tagging indicator.

In some implementations of the system, the system may include means for receiving a block tagging indicator from the agent device. In some implementations of the system, the system may include means for generating the indication to process PII data in a conversation block received from the client device in response to receiving the block tagging indicator.

In some implementations of the system, the system may include means for receiving a next response tagging indicator from the agent device. In some implementations of the system, the system may include means for generating the indication to process PII data in a next communication received from the client device in response to receiving the next response tagging indicator.

In some implementations of the system, the system may include means for saving the tokenized PII data to an encrypted database. In some implementations of the system, the system may include means for obtaining the tokenized PII data from the encrypted database to transmit on the first channel.

Even another aspect of the present disclosure relates to a computing platform configured for managing interactions between a client device and an agent device. The computing platform may include a non-transient computer-readable storage medium having executable instructions embodied thereon. The computing platform may include one or more hardware processors configured to execute the instructions. The processor(s) may execute the instructions to receive an indication to process personally identifiable information (PII) data in a chat system interaction between the client device and the agent device. The processor(s) may execute the instructions to tokenize the PII data. The processor(s) may execute the instructions to transmit the tokenized PII data on a first channel via a chat system server to the agent device. The processor(s) may execute the instructions to transmit the received and untokenized PII data on a second channel via a secure connection to the agent device. The processor(s) may execute the instructions to cause display at the agent device of a correlation between the untokenized PII data and the tokenized PII data.

In some implementations of the computing platform, the processor(s) may execute the instructions to cause display at the agent device of the untokenized PII data and the tokenized PII data as well as the correlation between the untokenized PII data and the tokenized PII data. In some implementations of the computing platform, the processor(s) may execute the instructions to cause concurrent display at the agent device of the untokenized PII data and the tokenized PII data as well as the correlation between the untokenized PII data and the tokenized PII data.

In some implementations of the computing platform, the processor(s) may execute the instructions to transmit the untokenized PII data on the second channel so as to prevent storage of the untokenized PII data in a chat system server transcript. In some implementations of the computing platform, the processor(s) may execute the instructions to transmit the untokenized PII data on the second channel in parallel with transmitting the tokenized PII data on the first channel.

In some implementations of the computing platform, the processor(s) may execute the instructions to cause display of the correlation between the received PII data and the tokenized PII data such that the correlation appears within a chat system interface at the agent device. In some implementations of the computing platform, the processor(s) may execute the instructions to cause display of the correlation between the received PII data and the tokenized PII data such that the correlation appears in a first user interface (UI) element of an application at the agent device, the first UI element being adjacent a second UI element of the application at the agent device, the second UI element comprising a chat system interface.

In some implementations of the computing platform, the processor(s) may execute the instructions to intercept first chat interaction data from the client device intended for the agent device. In some implementations of the computing platform, the processor(s) may execute the instructions to determine whether the first chat interaction data comprises PII data. In some implementations of the computing platform, the processor(s) may execute the instructions to generate the indication to process PII data in response to determining that the first chat interaction comprises PII data.

In some implementations of the computing platform, the processor(s) may execute the instructions to automatically tokenize the first chat interaction data in response to receiving the indication to process PII data, even in response to determining that the first chat interaction is free of PII data, to mitigate for a potential inadvertent incorrect determination of whether the first chat interaction comprises PII data.

In some implementations of the computing platform, the processor(s) may execute the instructions to receive input data from the client device. In some implementations of the computing platform, the processor(s) may execute the instructions to generate the indication to process PII data in response to determining that the input data comprises PII data.

In some implementations of the computing platform, the processor(s) may execute the instructions to receive a tagging indicator from the agent device. In some implementations of the computing platform, the processor(s) may execute the instructions to generate the indication to process PII data in communication received from the client device in response to receiving the tagging indicator.

In some implementations of the computing platform, the processor(s) may execute the instructions to receive a next response tagging indicator from the agent device. In some implementations of the computing platform, the processor(s) may execute the instructions to generate the indication to process PII data in a next communication received from the client device in response to receiving the next response tagging indicator.

In some implementations of the computing platform, the processor(s) may execute the instructions to receive a block tagging indicator from the agent device. In some implementations of the computing platform, the processor(s) may execute the instructions to generate the indication to process PII data in a conversation block received from the client device in response to receiving the block tagging indicator.

In some implementations of the computing platform, the processor(s) may execute the instructions to save the tokenized PII data to an encrypted database. In some implementations of the computing platform, the processor(s) may execute the instructions to obtain the tokenized PII data from the encrypted database to transmit on the first channel.

What is claimed is:

1. An apparatus configured for managing interactions between a client device and an agent device, the apparatus comprising:
a non-transient computer-readable storage medium having executable instructions embodied thereon; and
one or more hardware processors configured to execute the instructions to:
receive an indication to process personally identifiable information (PII) data in a chat system interaction between the client device and the agent device;
tokenize the PII data;
transmit the tokenized PII data on a first channel via a chat system server to the agent device;
transmit the received and untokenized PII data on a second channel via a secure connection to the agent device; and
cause display at the agent device of a correlation between the untokenized PII data and the tokenized PII data.

2. The apparatus of claim 1 wherein the one or more hardware processors are further configured to execute the instructions to:
cause concurrent display at the agent device of the untokenized PII data and the tokenized PII data as well as the correlation between the untokenized PII data and the tokenized PII data.

3. The apparatus of claim 1 wherein the one or more hardware processors are further configured to execute the instructions to:
transmit the untokenized PII data on the second channel in parallel with transmitting the tokenized PII data on the first channel.

4. The apparatus of claim 1 wherein the one or more hardware processors are further configured to execute the instructions to:
cause display of the correlation between the received PII data and the tokenized PII data such that the correlation appears in a first user interface (UI) element of an application at the agent device, the first UI element being adjacent a second UI element of the application at the agent device, the second UI element comprising a chat system interface.

5. The apparatus of claim 1 wherein the one or more hardware processors are further configured to execute the instructions to:
intercept first chat interaction data from the client device intended for the agent device;
determine whether the first chat interaction data comprises PII data; and
generate the indication to process PII data in response to determining that the first chat interaction comprises PII data.

6. The apparatus of claim 5 wherein the one or more hardware processors are further configured to execute the instructions to:
automatically tokenize the first chat interaction data in response to receiving the indication to process PII data, even in response to determining that the first chat interaction is free of PII data.

7. The apparatus of claim 1 wherein the one or more hardware processors are further configured to execute the instructions to:
receive a tagging indicator from the agent device;
generate the indication to process PII data in communication received from the client device in response to receiving the tagging indicator.

8. The apparatus of claim 1 wherein the one or more hardware processors are further configured to execute the instructions to:
save the tokenized PII data to an encrypted database; and
obtain the tokenized PII data from the encrypted database to transmit on the first channel.

9. The apparatus of claim 1 wherein the one or more hardware processors are further configured to execute the instructions to:
cause processing of the PII data when the chat system server is not configured to perform PII data processing without modifying the chat system server.

10. A method for managing interactions between a client device and an agent device, comprising:
receiving an indication to process personally identifiable information (PII) data in a chat system interaction between the client device and the agent device;
tokenizing the PII data;
transmitting the tokenized PII data on a first channel via a chat system server to the agent device;
transmitting the received and untokenized PII data on a second channel via a secure connection to the agent device; and
causing display at the agent device of a correlation between the untokenized PII data and the tokenized PII data.

11. The method of claim 10 further comprising:
causing concurrent display at the agent device of the untokenized PII data and the tokenized PII data as well as the correlation between the untokenized PII data and the tokenized PII data.

12. The method of claim 10 further comprising:
transmitting the untokenized PII data on the second channel in parallel with transmitting the tokenized PII data on the first channel.

13. The method of claim 10 further comprising:
causing display of the correlation between the received PII data and the tokenized PII data such that the correlation appears in a first user interface (UI) element of an application at the agent device, the first UI element being adjacent a second UI element of the application at the agent device, the second UI element comprising a chat system interface.

14. The method claim 10 further comprising:
intercepting first chat interaction data from the client device intended for the agent device;
determining whether the first chat interaction data comprises PII data; and
generating the indication to process PII data in response to determining that the first chat interaction comprises PII data.

15. The method of claim 14 further comprising:
automatically tokenizing the first chat interaction data in response to receiving the indication to process PII data, even in response to determining that the first chat interaction is free of PII data.

16. The method of claim 10 further comprising:
receiving a tagging indicator from the agent device;
generating the indication to process PII data in communication received from the client device in response to receiving the tagging indicator.

17. The method of claim 10 further comprising:
saving the tokenized PII data to an encrypted database; and
obtaining the tokenized PII data from the encrypted database to transmit on the first channel.

18. The method of claim 10 further comprising:
causing processing of the PII data when the chat system server is not configured to perform PII data processing without modifying the chat system server.

19. A non-transient computer-readable storage medium having instructions embodied thereon, the instructions being executable by one or more processors to perform a method for managing interactions between a client device and an agent device, comprising:
receiving an indication to process personally identifiable information (PII) data in a chat system interaction between the client device and the agent device;
tokenizing the PII data;
transmitting the tokenized PII data on a first channel via a chat system server to the agent device;
transmitting the received and untokenized PII data on a second channel via a secure connection to the agent device; and
causing display at the agent device of a correlation between the untokenized PII data and the tokenized PII data.

20. The non-transient computer-readable storage medium of claim 19 wherein the method further comprises:
receiving a tagging indicator from the agent device;
generating the indication to process PII data in communication received from the client device in response to receiving the tagging indicator.
